(19) United States
(12) Patent Application Publication
(10) Pub. No.: US 2025/0023410 A1
(43) Pub. Date: Jan. 16, 2025

(54) METHOD FOR DIMENSIONING A MULTI-POLE ORIENTED-FLUX MAGNETIC RING, AND ASSOCIATED ROTOR, ROTATING ELECTRIC MACHINE AND AIRCRAFT

(71) Applicant: SAFRAN, Paris (FR)

(72) Inventors: Benjamin Daguse, Moissy-Cramayel (FR); Sabrina Siham AYAT, Moissy-Cramayel (FR)

(73) Assignee: SAFRAN, Paris (FR)

(21) Appl. No.: 18/712,059

(22) PCT Filed: Nov. 21, 2022
(86) PCT No.: PCT/FR2022/052144

§ 371 Date: May 21, 2024

(30) Foreign Application Priority Data
Nov. 25, 2021 (FR) FR2112534

(51) Int. Cl. H02K 1/2783; B64D 27/32

(52) U.S. Cl. CPC H02K 1/2783; B64D 27/32

(57) ABSTRACT

The method for dimensioning a multi-pole oriented-flux magnetic ring for a rotor of a rotating electric machine, where the magnetic ring includes a predetermined number of pairs of poles, and the magnetic ring is formed by at least one oriented-flux magnet. The method includes determining a characteristic dimension of the magnet equal to the minimum value out of the outer perimeter of the ring and the axial length of the ring, determining a reference value equal to the minimum value out of a predetermined reference length and twice the value Pi, comparing the characteristic dimension of the magnet with the reference value, and if the characteristic dimension of the magnet is greater than the reference value, the method comprises circumferentially dividing the magnet into at least two sub-magnets.

### TECHNICAL FIELD OF THE INVENTION

The invention relates to optimising oriented-flux permanent magnets in a Halbach topology, and more particularly a method for dimensioning a multi-pole oriented-flux magnetic ring.

The invention furthermore relates to a rotor including such a magnetic ring, a rotating electric machine including such a rotor, and an aircraft including such a rotating electric machine.

### PRIOR ART

In order to increase the magnetic performances of a rotating electric machine, arranging permanent magnets in said machine in a Halbach topology to obtain better guidance of the magnetic flux in the air gap of the machine is known.

In this topology, the magnetic fields of the successive magnets are oriented so as to amplify the resulting magnetic field in the air gap while eliminating the resulting magnetic field on the opposite side of the magnets.

Securing a multi-pole oriented-flux magnet with an annular shape without radial segmentation on a cylindrical support to form a rotor is known.

FIG. 1 illustrates an example of such a rotor 1 known from the prior art.

The rotor 1 comprises a yoke 2 of radius 1c and a multi-pole oriented-flux magnetic ring 3 including a multi-pole oriented-flux magnet 4 in a Halbach topology.

The magnet 4 has an axial length 1z and a height 1R and includes the Np/2 pairs of poles.

The radius of the rotor 1 is equal to the sum R of the radius 1c of the yoke 2 and the height l_{R} of the magnet forming the ring 6.

However, the magnet generates high losses by eddy current.

Furthermore, as the support and the magnet are formed from different materials having different coefficients of expansion, when the annular magnet is heated stresses appear in the rotor, liable to crack or break the annular magnet.

Document EP3736944 discloses an example of a rotor including permanent magnets in a Halbach topology.

In order to minimise the losses by eddy current proportional to the square of the smallest dimension of the magnets, each rotor magnetic pole is composed of ten magnets segmented in an axial direction.

However, to arrange the permanent magnets in the Halbach topology, it is necessary to manufacture, crop and glue to the rotor a considerable number of magnets, thus increasing the duration and complexity of manufacture of the rotor.

The aim of the invention is to overcome all or some of these drawbacks.

### DESCRIPTION OF THE INVENTION

In light of the above, the object of the invention is a method for dimensioning a multi-pole oriented-flux magnetic ring for a rotor of a rotating electric machine, the magnetic ring including a predetermined number of pairs of poles, the magnetic ring being formed by at least one oriented-flux magnet.

The method comprises:
determining a characteristic dimension of the magnet equal to the minimum value out of the outer perimeter of the ring and the axial length of the ring,
determining a reference value equal to the minimum value out of a predetermined reference length and twice the value Pi,
comparing the characteristic dimension of the magnet with the reference value, and
if the characteristic dimension of the magnet is greater than the reference value, the method comprises the circumferential segmentation of the magnet into at least two sub-magnets.

The circumferential segmentation of the magnet into at least two sub-magnets in accordance with the method makes it possible to minimise the losses by eddy current in the ring formed by the sub-magnets while minimising the number of sub-magnets to be manufactured and glued to a rotor yoke to form the magnetic ring in order to reduce the duration and complexity of manufacture of a rotor including the yoke and the ring.

Preferably, if the characteristic dimension of the magnet is less than or equal to the reference value, the magnet is not circumferentially segmented into sub-magnets.

Advantageously, the circumferential segmentation of the magnet into at least two sub-magnets comprises:
breaking down the number of poles of the ring into prime numbers,
determining a characteristic number equal to the smallest prime number out of a set of prime numbers comprising the prime numbers,
a) determining a second reference value equal to the minimum value out of the predetermined reference length and twice the value Pi divided by a characteristic sum equal to at least the value of the characteristic number,
b) determining a second characteristic dimension equal to the minimum value out of the outer perimeter of the ring divided by the characteristic number and the axial length of the ring,
c) comparing the second characteristic dimension of the magnet with the second reference value, and
if the second characteristic dimension is less than or equal to the second reference value, the magnet is segmented into a number of sub-magnets equal to the sum, each sub-magnet having an angular sector with respect to the centre of the ring equal to the value twice Pi divided by the sum, and each sub-magnet comprising a number of poles equal to the number of poles of the ring divided by the sum.

Preferably, if the second characteristic dimension is greater than the second reference value and the set of prime numbers is not empty, the method comprises:
determining the characteristic number equal to the smallest prime number out of the set of prime numbers from which the smallest prime number previously selected is subtracted,
reiterating step a), wherein the characteristic sum is equal to the multiplication of the characteristic number by the smallest prime number previously selected,
reiterating step b), and
reiterating step c).

Advantageously, if the set of prime numbers is empty, the magnet is not segmented into sub-magnets.

Preferably, if a first sub-magnet is formed from a first material and the second sub-magnet is formed from a second material different from the first material, the second reference value is equal to the minimum value multiplied by a coefficient equal to the multiplication of the first coefficient by a second coefficient, the first coefficient being equal to the density of the second material divided by the density of the first material, and the second coefficient being equal to the electrical conductivity of the second material divided by the electrical conductivity of the first material.

A rotor is also proposed for a rotating electric machine including a magnetic ring obtained by a method as defined above.

A rotating electric machine including a rotor as defined above is also proposed.

An aircraft including a rotating electric machine as defined above is also proposed.

### BRIEF DESCRIPTION OF THE DRAWINGS

Other aims, features and advantages of the invention will appear upon reading the following description, given solely as a non-limiting example, and made with reference to the appended drawings wherein:

FIG. 1 illustrates schematically a rotor known from the prior art;

FIG. 2 illustrates schematically an aircraft according to the invention;

FIG. 3 illustrates schematically an example of the rotor according to the invention;

FIG. 4 illustrates schematically an example of a method for implementing the sizing device according to the invention;

FIG. 5 illustrates schematically a second example of the rotor according to the invention; and

FIG. 6 illustrates schematically a third example of the rotor according to the invention.

### DETAILED DESCRIPTION OF AT LEAST ONE EMBODIMENT

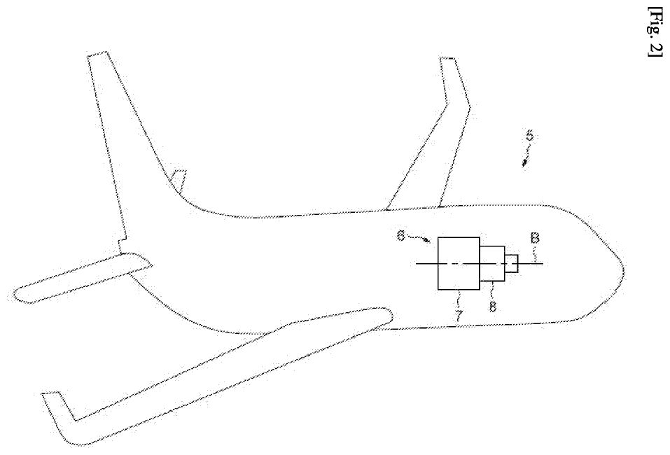

Reference is made to FIG. 2, which illustrates schematically an aircraft 5 comprising a rotating electric machine 6 including a wound stator 7 having a central axis B, and a rotor 8 disposed in the stator 7 and including Np poles, i.e. Np/2 pairs of poles.

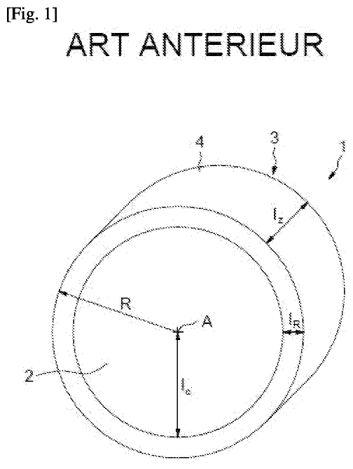

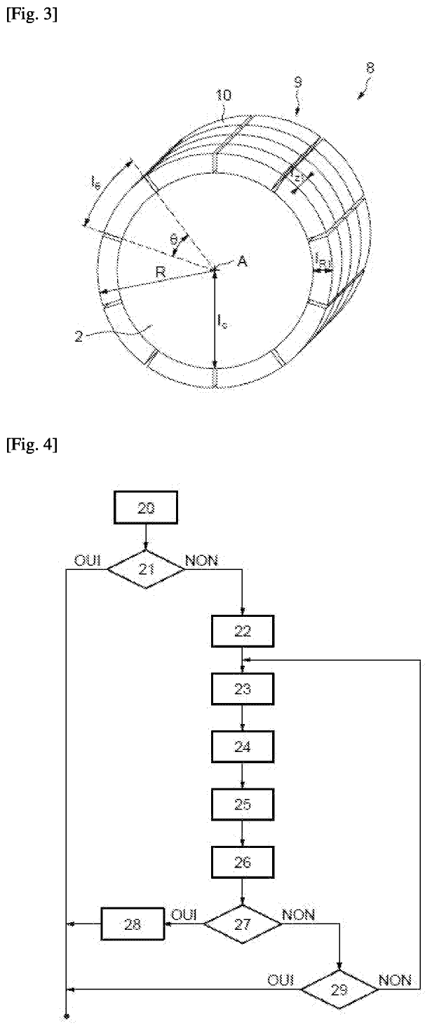

FIG. 3 illustrates an example of the rotor 8 according to the invention determined from the rotor known from the prior art and illustrated in FIG. 1.

The rotor 8 comprises the yoke 2 surrounded by a multi-pole oriented-flux ring 9 formed by oriented-flux segmented sub-magnets 10 in a Halbach topology.

It is supposed that the sub-magnets 10 have the same dimensions.

Each sub-magnet 10 has an axial length lz₁, a height l_{R1} and a circumferential length l_{θ} defined by an angular sector θ with respect to the centre of the ring 6.

The height l_{R1} of the sub-magnets 10 is equal to the height l_{R} of the magnet forming the ring 6 of the rotor 1 known from the prior art.

The sub-magnets 10 are segmented in an axial direction.

The sum of the axial length lz₁ of the sub-magnets 10 is equal to the axial length lz of the magnet 7.

The radius of the rotor 8 is equal to the sum R of the radius lc of the yoke 2 and the height l_{R1} of the sub-magnets 10.

Each sub-magnet 10 comprises 1/n_{H} poles, n_{H} being the number of sub-magnets 10 to form one pole.

The circumferential length l_{θ} or orthogonal length is equal to:

$${l}_{θ} = \frac{2 π R}{{N}_{p} {n}_{H}} \qquad ( 1 )$$

When the segmented sub-magnets 10 are not all the same size within one and the same pole of the ring 9, it is necessary to select the orthogonal length of the smallest sub-magnet of the pole.

For example, for a Halbach topology including two sub-magnets per pole, breaking down the sub-magnets so that the orthogonal length of a first sub-magnet is equal to half the orthogonal length of the second sub-magnet is known.

In this case the circumferential length l_{θ} or orthogonal length is equal to:

$${l}_{θ} = \frac{2 π R}{3 {N}_{p}} \qquad ( 2 )$$

The dimensions of the sub-magnets 10 are determined so that the losses by eddy currents are minimised in the ring 9 formed by the sub-magnets 10, and so that the number of sub-magnets 10 to be manufactured and glued to the yoke 2 are reduced in order to reduce the duration and complexity of manufacture of the rotor 8 by a dimensioning device to dimension the sub-magnets 10 in order to minimise the losses by eddy current in said sub-magnets 10 and in order to minimise the number of sub-magnets 10 forming the ring 9.

The device comprises for example a configured processing unit.

FIG. 4 illustrates an example of a method for implementing the device.

It is supposed that, at the start of the method, the ring 9 comprises the multi-pole magnet forming the ring 3 of the rotor illustrated in FIG. 1.

During a step 20, the device 11 determines a characteristic dimension l_{z,SFM} of the magnet 4 forming the ring 3 equal to the minimum value out of the outer perimeter 2πR of the ring 3 of the rotor 1 and the axial length lz of the ring. The device 11 furthermore determines a reference value Vref equal to the minimum value out of a predetermined reference length lref and twice the value Pi.

The reference length lref is for example equal to the maximum value selected out of the axial length lz, the height 1R or the perimeter of the ring equal to 2πR of the magnet 4 illustrated in FIG. 1.

During a step 21, the device 11 compares the characteristic dimension l_{z,SFM} with the value Vref.

If the characteristic dimension l_{z,SFM} is less than or equal to the value Vref, the magnet 4 forming the ring 3 of the rotor 1 is not circumferentially segmented.

The ring 9 of the rotor 8 is formed by the annular multi-pole magnet 4 forming the ring 3 of the rotor 1.

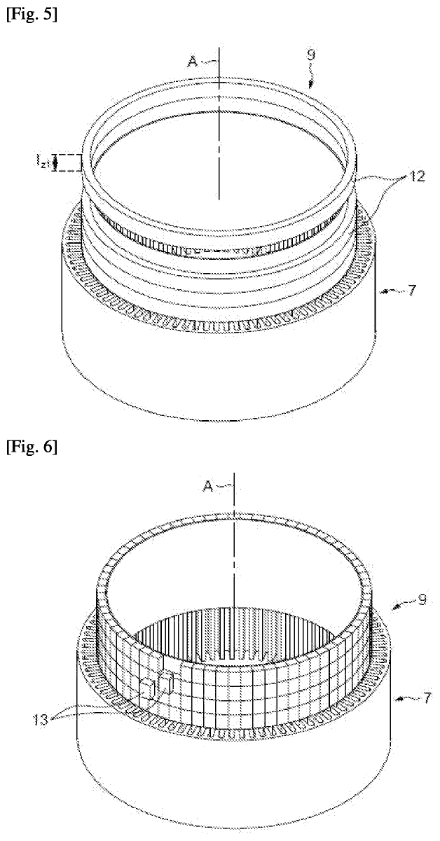

FIG. 5 illustrates a second example of the rotor 8 including annular magnets 12, the magnet 4 of the ring 3 having for example been segmented axially into annular magnets of axial length l_{z1} to minimise losses by eddy current.

If the characteristic dimension l_{z,SEM} of the magnet 4 is greater than the reference value Vref, the magnet 4 is segmented circumferentially into at least two sub-magnets 10.

To determine the number of sub-magnets 10 in order to minimise losses by eddy current in said sub-magnets 10 and in order to minimise the number of sub-magnets 10 forming the ring 9, the device breaks down the number of poles Np of the rotor 8 into prime numbers (step 22) so that:

$${N}_{p} = {\prod }_{k = 1}^{P} {P}_{k} \qquad ( 3 )$$

where, as the number of poles Np is necessarily even, P₁=2, and Pₖ<Pₖ₊₁.

Furthermore, an integer variable i is initialised to the value 0.

During a step 23, the variable i is incremented by one unit.

Then, during a step 24, the device 11 determines a characteristic number NUM equal to the smallest prime number Pᵢ out of a set of prime numbers comprising the prime numbers Pₖ, k varying from 1 to Np.

During a step 25, the device 11 furthermore determines a second reference value Vref2 equal to the minimum value out of the predetermined reference length lref and twice the value Pi divided by a characteristic sum SOM equal to at least the value of the characteristic number NUM such that:

$$S OM = {\prod }_{n = 1}^{i} {P}_{n} \qquad ( 4 )$$

During a step 26, the device 11 furthermore determines a second characteristic dimension l_{z,SFM}2 equal to the minimum value out of the outer perimeter 2πR of the ring 3 divided by the characteristic number NUM and the axial length lz of the ring.

During a step 27, the device 11 compares the second characteristic dimension l_{z,SFM}2 with the second value Vref2.

If the second characteristic dimension 1_{z,SFM}2 is less than or equal to the second value Vref2, the device 11 determines that the magnet 4 forming the ring 3 is segmented into a number of sub-magnets 10 equal to the sum SOM, each sub-magnet 10 having an angular sector with respect to the centre of the ring 9 equal to the value twice Pi divided by the sum SOM, and each sub-magnet 10 comprising a number of poles equal to the number of poles Np of the ring 9 divided by the sum SOM (step 28).

If the second characteristic dimension 12, SEM2 is greater than the second value Vref2, and the set of prime numbers is not empty (step 29), the method continues at step 23 by incrementing the value i, and then reiterates step 24 by determining the characteristic number NUM equal to the smallest prime number out of the set of prime numbers from which the smallest prime number previously selected is subtracted.

Then the method continues at the following steps.

If the set of prime numbers is empty (step 29), the magnet 4 is not segmented into sub-magnets 8.

The ring 9 of the rotor 8 is formed by the annular multi-pole magnet 4 forming the ring 3 of the rotor 1.

If a first sub-magnet is formed from a first material with a density ρ1 and electrical conductivity r1, and a second sub-magnet is formed from a second material with a density ρ2 and electrical conductivity r2, the second reference value Vref2 is multiplied by a coefficient COEFF such that:

$$COEFF = \frac{r 2}{r 1} \frac{ρ 2}{ρ 1} \qquad ( 5 )$$

FIG. 6 illustrates a third example of the rotor 8 including the ring 9 formed by sub-magnets 13, each sub-magnet 13 forming a poll of the ring 9.

The ring 9 can comprise the annual magnet 4, or one or more oriented-flux sub-magnets, each sub-magnet corresponding to a pair of poles or each sub-magnet corresponding to one pole depending on the result of the dimensioning method.

1. A method for dimensioning a multi-pole oriented-flux magnetic ring for a rotor of a rotating electric machine, the magnetic ring including a predetermined number of pairs of poles, the magnetic ring being formed by at least one oriented-flux magnet, the method comprises:
determining a characteristic dimension of the magnet equal to the minimum value out of the outer perimeter of the ring and the axial length of the ring,
determining a reference value equal to the minimum value out of a predetermined reference length and twice the value Pi,
comparing the characteristic dimension of the magnet with the reference value, and
if the characteristic dimension of the magnet is greater than the reference value, the method comprises the circumferential segmentation of the magnet into at least two sub-magnets.

2. The method according to claim 1, wherein, if the characteristic dimension of the magnet is less than or equal to the reference value, the magnet is not circumferentially segmented into sub-magnets.

3. The method according to claim 1, wherein the circumferential segmentation of the magnet into at least two sub-magnets comprises:
breaking down the number of poles of the ring into prime numbers,
determining a characteristic number equal to the smallest prime number out of a set of prime numbers comprising the prime numbers,
a) determining a second reference value equal to the minimum value out of the predetermined reference length and twice the value Pi divided by a characteristic sum equal to at least the value of the characteristic number,
b) determining a second characteristic dimension equal to the minimum value out of the outer perimeter of the ring divided by the characteristic number and the axial length of the ring,
c) comparing the second characteristic dimension of the magnet with the second reference value, and
if the second characteristic dimension is less than or equal to the second reference value, the magnet is segmented into a number of sub-magnets equal to the sum, each sub-magnet having an angular sector with respect to the centre of the ring equal to the value twice Pi divided by the sum, and each sub-magnet comprising a number of poles equal to the number of poles of the ring divided by the sum.

4. The method according to claim 3, wherein, if the second characteristic dimension is greater than the second reference value and the set of prime numbers is not empty, the method comprises:
determining the characteristic number equal to the smallest prime number out of the set of prime numbers from which the smallest prime number previously selected is subtracted,
reiterating step a), wherein the characteristic sum is equal to the multiplication of the characteristic number by the smallest prime number previously selected,
reiterating step b), and
reiterating step c).

5. The method according to claim 4, wherein, if the set of prime numbers is empty, the magnet is not segmented into sub-magnets.

6. The method according to claim 3, wherein, if a first sub-magnet is formed from a first material and the second sub-magnet is formed from a second material different from the first material, the second reference value is equal to the minimum value multiplied by a coefficient equal to the multiplication of the first coefficient by a second coefficient, the first coefficient being equal to the density of the second material divided by the density of the first material, and the second coefficient being equal to the electrical conductivity of the second material divided by the electrical conductivity of the first material.

7. A rotor for a rotating electric machine including a magnetic ring comprising a predetermined number of pairs of poles, the magnetic ring being formed by an oriented-flux magnet segmented into at least two sub-magnets, wherein the minimum value out of the outer perimeter of the ring and the axial length of the ring is greater than the minimum value out of the value of a predetermined reference length and twice the value Pi.

8. A rotating electric machine including a rotor according to claim 7.

9. An aircraft including a rotating electric machine according to claim 8.
